(19) United States
(12) Patent Application Publication
(10) Pub. No.: US 2025/0392658 A1
(43) Pub. Date: Dec. 25, 2025

(54) Electronic Devices and Corresponding Methods for Indicating Content Creating Device Geometric Form Factor

(71) Applicant: Motorola Mobility LLC, Chicago, IL (US)

(72) Inventors: Amit Kumar Agrawal, Bangalore (IN); Srinivasan Arthanari, Bangalore (IN); Xiaofeng Zhu, Nanjing (CN); T Gokularamanan Thiruppathi, Bangalore (IN)

(21) Appl. No.: 18/784,634

(22) Filed: Jul. 25, 2024

Related U.S. Application Data
(63) Continuation of application No. PCT/CN2024/100611, filed on Jun. 21, 2024.

(51) Int. Cl. H04M 1/02

(52) U.S. Cl. CPC H04M 1/0268; H04M 1/0216; H04M 1/0245; H04M 2250/12

(57) ABSTRACT

An electronic device with a deformable housing supports at least one display and includes sensors to detect the device's geometric configuration. Processors, operable with the sensors, present content with visual indicia that identify the deformed geometry at which the content was originally created, unless the current device configuration matches the original geometric configuration. The visual indicia may include instructions for adjusting the device to match the original geometry, enhancing the playback experience. The content's originating geometric configuration can be stored as metadata, allowing for accurate reconstruction during playback. This system addresses the challenges of screen recording and playback on foldable devices by incorporating the device's folding angle information into the screen recording process, thus ensuring playback reflects the original recording conditions.

### CROSS REFERENCE TO PRIOR APPLICATIONS

This application is a continuation claiming priority and benefit under 35 U.S.C. § 120, pursuant to 35 U.S.C. § 365(a), to PCT Application Ser. No. PCT/CN2024/100611, filed Jun. 21, 2024, which is incorporated by reference for all purposes. See MPEP § 1895.

### BACKGROUND

### Technical Field

This disclosure relates generally to electronic devices, and more particularly to electronic devices having user interfaces operable to present content.

### Background Art

The feature sets included with modern portable electronic devices, such as smartphones, tablet computers, smart watches, and other devices, are increasingly becoming richer and more sophisticated. Illustrating by example, while mobile phones were once equipped with simplistic backlit displays having only large grey scale pixels, modern smartphones frequently include high definition organic light emitting diode displays with incredibly small pixels and extremely high contrast ratios capable of presenting high dynamic range images and videos. Many consumers today eschew television sets, instead consuming entire television shows, and even feature length movies, using only a smartphone.

In deformable electronic devices, since there are so many possible geometric form factors it can be difficult to ascertain in which geometric form factor an electronic device may have been when performing a particular operation. It would be advantageous to have improved deformable electronic devices and corresponding systems that alleviate this issue.

### BRIEF DESCRIPTION OF THE DRAWINGS

The accompanying figures, where like reference numerals refer to identical or functionally similar elements throughout the separate views and which together with the detailed description below are incorporated in and form part of the specification, serve to further illustrate various embodiments and to explain various principles and advantages all in accordance with the present disclosure.

FIG. 1 illustrates one explanatory electronic device configured in accordance with one or more embodiments of the disclosure.

FIG. 2 illustrates a perspective view of one explanatory electronic device in accordance with one or more embodiments of the disclosure in a closed position.

FIG. 3 illustrates a side elevation view of one explanatory electronic device in accordance with one or more embodiments of the disclosure in a partially open position.

FIG. 4 illustrates a side elevation view of one explanatory electronic device in accordance with one or more embodiments of the disclosure in an axially displaced open position.

FIG. 5 illustrates one explanatory method for an explanatory electronic device in accordance with one or more embodiments of the disclosure.

FIG. 6 illustrates a user creating content while an electronic device in accordance with one or more embodiments of the disclosure is in a deformed geometric form factor.

FIG. 7 illustrates another explanatory method in accordance with one or more embodiments of the disclosure.

FIG. 8 illustrates still another explanatory method in accordance with one or more embodiments of the disclosure.

FIG. 9 illustrates a user consuming content with an electronic device configured in accordance with one or more embodiments of the disclosure.

FIG. 10 illustrates one or more embodiments of the disclosure.

Skilled artisans will appreciate that elements in the figures are illustrated for simplicity and clarity and have not necessarily been drawn to scale. For example, the dimensions of some of the elements in the figures may be exaggerated relative to other elements to help to improve understanding of embodiments of the present disclosure.

### DETAILED DESCRIPTION OF THE DRAWINGS

Before describing in detail embodiments that are in accordance with the present disclosure, it should be observed that the embodiments reside primarily in combinations of method steps and apparatus components related to presenting, by a user interface of an electronic device, content with visible indicia indicating an originating electronic device geometric configuration at which the content was created unless a geometric configuration of the electronic device substantially matches the originating electronic device geometric configuration. Any process descriptions or blocks in flow charts should be understood as representing modules, segments, or portions of code which include one or more executable instructions for implementing specific logical functions or steps in the process.

Alternate implementations are included, and it will be clear that functions may be executed out of order from that shown or discussed, including substantially concurrently or in reverse order, depending on the functionality involved. Accordingly, the apparatus components and method steps have been represented where appropriate by conventional symbols in the drawings, showing only those specific details that are pertinent to understanding the embodiments of the present disclosure so as not to obscure the disclosure with details that will be readily apparent to those of ordinary skill in the art having the benefit of the description herein.

Embodiments of the disclosure do not recite the implementation of any commonplace business method aimed at processing business information, nor do they apply a known business process to the particular technological environment of the Internet. Moreover, embodiments of the disclosure do not create or alter contractual relations using generic computer functions and conventional network operations. Quite to the contrary, embodiments of the disclosure employ methods that, when applied to electronic device and/or user interface technology, improve the functioning of the electronic device itself by and improving the overall user experience to overcome problems specifically arising in the realm of the technology associated with electronic device user interaction.

It will be appreciated that embodiments of the disclosure described herein may be comprised of one or more conventional processors and unique stored program instructions that control the one or more processors to implement, in conjunction with certain non-processor circuits, some, most, or all of the functions of identifying a deformed geometry at which an originating electronic device was configured when creating the content with visual indicia identifying the deformed geometry unless one or more sensors of the electronic device detect a deformable device housing substantially matching the deformed geometry as described herein. The non-processor circuits may include, but are not limited to, a radio receiver, a radio transmitter, signal drivers, clock circuits, power source circuits, and user input devices. As such, these functions may be interpreted as steps of a method to perform presenting, by one or more processors on the user interface, the content within an electronic device depiction having the at least one geometric configuration until the electronic device transitions to the at least one geometric configuration.

Alternatively, some or all functions could be implemented by a state machine that has no stored program instructions, or in one or more application specific integrated circuits (ASICs), in which each function or some combinations of certain of the functions are implemented as custom logic. Of course, a combination of the two approaches could be used. Thus, methods and means for these functions have been described herein. Further, it is expected that one of ordinary skill, notwithstanding possibly significant effort and many design choices motivated by, for example, available time, current technology, and economic considerations, when guided by the concepts and principles disclosed herein will be readily capable of generating such software instructions and programs and ASICs with minimal experimentation.

Embodiments of the disclosure are now described in detail. Referring to the drawings, like numbers indicate like parts throughout the views. As used in the description herein and throughout the claims, the following terms take the meanings explicitly associated herein, unless the context clearly dictates otherwise: the meaning of “a,” “an,” and “the” includes plural reference, the meaning of “in” includes “in” and “on.” Relational terms such as first and second, top and bottom, and the like may be used solely to distinguish one entity or action from another entity or action without necessarily requiring or implying any actual such relationship or order between such entities or actions.

As used herein, components may be “operatively coupled” when information can be sent between such components, even though there may be one or more intermediate or intervening components between, or along the connection path. The terms “substantially,” “essentially,” “approximately,” “about,” or any other version thereof, are defined as being close to as understood by one of ordinary skill in the art, and in one non-limiting embodiment the term is defined to be within ten percent, in another embodiment within five percent, in another embodiment within one percent and in another embodiment within one-half percent.

The term “coupled” as used herein is defined as connected, although not necessarily directly and not necessarily mechanically. Also, reference designators shown herein in parenthesis indicate components shown in a figure other than the one in discussion. For example, talking about a device (10) while discussing figure A would refer to an element, 10, shown in figure other than figure A.

Embodiments of the disclosure provide an electronic device that is geometrically deformable. In one or more embodiments, the electronic device includes a first device housing that is pivotable about a hinge relative to a second device housing between a closed position and an axially displaced open position. In one or more embodiments, the hinge is configured as a “friction hinge” that allows a user to pivot the first device housing relative to the second device housing to any position between the closed position and the axially displaced open position with that device geometry being retained by a frictional element situated in the hinge. Effectively, this hinge allows users to keep the device in a partially folded position, enabling new ways to utilize both the internal and external screens.

This partial bending can cause the electronic device to resemble the partial bend exhibited by a laptop computer. Thus, even though the electronic device may be a smartphone, some refer to this partially bent state as being the “laptop geometric form factor” or “laptop mode.” In other embodiments, the electronic device will include a deformable housing allowing a user to move a first device housing portion relative to a second device housing portion to various positions between the closed position and the axially displaced open position.

In some embodiments, this ability to deform the electronic device and manipulate it between the closed position and the axially displaced open position allows for the inclusion of a second display, which is sometimes known as a “quick view display” or “qvd” due to the fact that it is always exposed regardless of whether the electronic device is in the axially displaced open position or the closed position. By contrast, in some embodiments the primary display is concealed when the electronic device is in the closed position and revealed as the electronic device transitions from the closed position to the axially displaced open position.

Inclusion of the second display allows users of the electronic device to get information at a quick glance when the electronic device is in the closed position without having to transition the electronic device from the closed position to the axially displaced open position. Another advantage offered by this provision of the second display is that in one or more embodiments it provides a substantial amount of area upon which to present content such as images or videos.

When an electronic device is equipped with the friction hinge, this innovative form factor also introduces unique challenges, particularly in the realm of screen recording and playback. Embodiments of the disclosure contemplate that a user may partially deform the electronic device between the axially displaced open position and the closed position and keep the electronic device in that geometric form factor when creating content, one example of which is a screenshot.

Currently, the on-screen video recorder function of the primary display of electronic devices does not capture the folding angle information. As a result, the playback of recorded videos does not indicate whether the video was recorded in an unfolded mode or a folded laptop mode. This lack of information can lead to confusion, especially when certain applications, like the camera application, show a blank screen for the lower portion of the display in laptop mode. Users might mistakenly consider this blank screen a defect during playback.

Moreover, even if a video recorded in laptop mode is played back on the same device, it is challenging to set the folding angle to match the original recording angle, leading to a suboptimal viewing experience. This issue is further compounded when such videos are played back on non-foldable phones, as there is no way to visualize the foldable device's unique form factor. These challenges highlight the need for a solution that can manage screen capture, recording, and playback on foldable devices more effectively.

Advantageously, embodiments of the disclosure provide a solution to this problem. To address the challenges associated with screen recording and playback on foldable devices, embodiments of the disclosure offer an innovative solution that enhances the user experience by incorporating folding angle information into the screen recording process. This approach enables users to record the screen on a foldable device along with the angle of deformation information, i.e., how far the first device housing is pivoted about the hinge relative to the second device housing and supports playback of the recorded content with the corresponding deformation, thereby ensuring that the viewing experience matches the original recording conditions.

In one or more embodiments, methods and devices described herein are operable with a screen recorder/player function operating in a deformable electronic device. In one or more embodiments, the recorder/player is capable of recording content being presented on the flexible display along with flexible display folding angle information. In one or more embodiments, the recorder/player further records any changes in the angle between the first device housing and second device housing that may occur throughout the recording. In one or more embodiments, the recorder/player can also document the folding state, such as whether the deformable electronic device is in a laptop, an axially displaced open position, or a closed position in a book mode, as well as any transitions between these states during the recording session. By embedding this information into the recorded media file, the playback can accurately reflect the original recording conditions.

During playback, in one or more embodiments the system checks whether the media is being played on a foldable device in the same folding state as the recording, a different folding state, or on a non-foldable device. If the playback occurs on a foldable device, in one or more embodiments the system creates a three-dimensional visual model of the video output, representing the folding angle information. In one or more embodiments, this model provides visual feedback to guide the user in adjusting the device's folding angle to match the original recording state. Once the consuming deformable electronic device is adjusted to the correct angle, in one or more embodiments the screen recording is displayed in full screen without the three-dimensional model, thereby offering an immersive viewing experience.

For playback on non-foldable devices, in one or more embodiments the system presents the recorded content using a three-dimensional modeled video output artifact, visually representing the folding angle information. This ensures that users can still understand the context of the recording, even if their device does not support folding. By incorporating these features, embodiments of the disclosure significantly improve the usability and viewing experience of screen recordings on foldable devices, thereby addressing the unique challenges posed by this innovative form factor.

In one or more embodiments, a method in an electronic device comprises presenting, by a user interface, content with visible indicia indicating an originating electronic device geometric configuration at which the content was created unless a geometric configuration of the electronic device substantially matches the originating electronic device geometric configuration. In one or more embodiments, the originating electronic device geometric configuration is written to metadata of the content.

In one or more embodiments, the visible indicia depict an originating electronic device. In one or more embodiments, the content is presented on a display of the originating electronic device depicted in the visible indicia.

In one or more embodiments, the visible indicia depict the originating electronic device in a partially deformed geometry defined by the originating electronic device geometric configuration. In one or more embodiments, the visible indicia depict the originating electronic device having a first device housing that is pivotable about a hinge relative to a second device housing between an axially displaced open position and a closed position. In one or more embodiments, the visible indicia further depict the originating electronic device with the first device housing pivoted relative about the hinge relative to the second device housing partially between the axially displaced open position and the closed position.

By presenting content with visible indicia indicating the originating electronic device geometric configuration, the method ensures that users can understand the context in which the content was created. This is particularly useful for foldable devices where the geometric configuration can significantly impact the viewing experience. For example, if a video was recorded in a partially folded state, in one or more embodiments the method will display the content within a visual model of the device in that same partially folded state, thereby providing a more immersive and contextually accurate playback experience.

Incorporating the geometric configuration into the content presentation also allows users to adjust their device to match the original recording state, thereby enhancing the accuracy and quality of the playback experience. This visual feedback helps users achieve the same viewing conditions as when the content was created, which is especially important for applications that behave differently based on the device's folding state.

Additionally, this method addresses the issue of playing back content on non-foldable devices by providing a visual representation of the foldable device's geometric configuration. This ensures that users can still understand the context of the recording, even if their device does not support folding, thereby improving the overall usability and viewing experience of screen recordings on foldable devices.

In one or more embodiments, a method in an electronic device comprises receiving, by a user interface, user input requesting a presentation of content having written to its metadata at least one geometric configuration of an originating electronic device occurring when the content was created. In one or more embodiments, the method comprises presenting, by one or more processors on the user interface, the content within an electronic device depiction having the at least one geometric configuration until the electronic device transitions to the at least one geometric configuration

By receiving user input requesting the presentation of content with metadata indicating the geometric configuration of the originating electronic device, the method ensures that the playback experience accurately reflects the original recording conditions. This is particularly useful for foldable devices where the geometric configuration can significantly impact the viewing experience.

Presenting the content within an electronic device depiction having the at least one geometric configuration until the electronic device transitions to the same configuration also allows users to understand the context in which the content was created. This visual feedback helps users adjust their device to match the original recording state, thereby enhancing the accuracy and quality of the playback experience.

For example, if a video was recorded in a partially folded state, the method will display the content within a visual model of the device in that same partially folded state. This ensures that users can see how the device was configured during recording, providing a more immersive and contextually accurate playback experience.

In one or more embodiments, an electronic device comprises a deformable device housing supporting at least one display, one or more sensors operable to detect a geometric configuration of the deformable device housing, and one or more processors operable with the one or more sensors. In one or more embodiments, the one or more processors present content identifying a deformed geometry at which an originating electronic device was configured when creating the content with visual indicia identifying the deformed geometry unless the one or more sensors detect the deformable device housing substantially matching the deformed geometry.

By incorporating one or more sensors to detect the geometric configuration of the deformable device housing, the electronic device can accurately determine the current state of the device's form factor. This allows the device to present content with visual indicia that reflect the deformed geometry at which the content was originally created, thereby ensuring that the playback experience is contextually accurate and immersive.

The use of processors operable with these sensors enables real-time monitoring and adjustment of the content presentation based on the detected geometric configuration. This dynamic adjustment ensures that the content is displayed correctly, whether the device is in a folded, partially folded, or fully open state, thereby enhancing the user experience by providing a seamless transition between different device states.

Additionally, the ability to present content with visual indicia identifying the deformed geometry unless the sensors detect a matching geometric configuration ensures that users are always aware of the original recording conditions. This feature is particularly useful for applications that behave differently based on the device's folding state, thereby preventing confusion and improving the overall usability of the device.

For example, when a video recorded in a partially folded state is played back, the device can use the sensors to detect its current state and adjust the playback accordingly. If the device is not in the same partially folded state, the visual indicia will guide the user to adjust the device to match the original recording state, ensuring an accurate and high-quality playback experience.

The solution flow for managing screen capture, recording, and playback on foldable devices is designed to ensure that the recorded content accurately reflects the original recording conditions, thereby enhancing the user experience. Users can use an electronic device configured in accordance with one or more embodiments of the disclosure as follows:

In one or more embodiments, the process begins with the screen recorder function operating while the device is in laptop mode. During this phase, in one or more embodiments the system captures the folding angle of the device and records it as metadata within the video file. This metadata includes information about the display's folding angle and any changes that occur throughout the recording session.

Once the recording is complete, in one or more embodiments the output is divided into two separate video files: one for the upper display area and another for the lower display area. In one or more embodiments, these two videos are then merged, with a split indication denoting the laptop mode folding angle. This approach ensures that the recorded content accurately represents the device's state during the recording session.

During playback, in one or more embodiments the system checks the current folding state of the device presenting the recorded content. If the playback occurs on a foldable device, in one or more embodiments the system creates a three-dimensional visual model of the video output, thereby depicting and/or representing the folding angle information. In one or more embodiments, this model provides visual feedback to guide the user in adjusting the device's folding angle to match the original recording state. As the consuming device is brought to the correct folding state and angle, the screen recording is displayed in full screen without the three-dimensional model, thereby offering an immersive viewing experience.

If the playback occurs on a non-foldable device, in one or more embodiments the system presents the recorded content using a three-dimensional modeled video output artifact, visually representing the folding angle information. This ensures that users can still understand the context of the recording, even if their device does not support folding. By incorporating these features, the solution flow significantly improves the usability and viewing experience of screen recordings on foldable devices, addressing the unique challenges posed by this innovative form factor.

Summarizing, in one or more embodiments a detailed visual representation of the process for managing screen capture, recording, and playback is presented on foldable devices. In one or more embodiments, it begins with capturing the screen while the device is in a partially folded state, such as laptop mode, and recording the folding angle as metadata within the video file. In one or more embodiments, the recorded content is divided into separate video files for different display areas and subsequently merged with indications of the folding angle.

During playback, in one or more embodiments the system checks the current folding state of the device and creates a three-dimensional visual model of the video output, guiding the user to adjust the device's folding angle to match the original recording state. If the playback occurs on a non-foldable device, in one or more embodiments the system presents the content using a three-dimensional modeled video output artifact, ensuring that users can understand the context of the recording. This visual representation helps to clarify the innovative approach and enhances the overall usability and viewing experience of screen recordings on foldable devices.

Thus, previous users of prior art electronic devices often encounter challenges related to the screen capture and playback of content, such as when capturing screen content on foldable devices, as the prior art does not account for the geometric configuration of the device at the time of recording. This omission results in playback that lacks contextual information about the device's form factor during the capture, leading to potential confusion and a diminished user experience.

Existing solutions for screen capture on foldable devices fail to provide a mechanism to discern whether content was created while the device was in an unfolded, fully open state or in a folded state, such as a laptop mode. This limitation becomes particularly evident when applications display differently depending on the device's configuration, such as showing a blank area on part of the screen when in a folded state. Without the ability to identify the device's geometric configuration during playback, users may mistakenly perceive such outcomes as defects or errors in the device's functionality.

Advantageously, embodiments of the present disclosure introduce methods and systems for managing screen capture, recording, and playback of content on foldable devices that overcomes the aforementioned disadvantages. The disclosed solution enables the recording of screen content along with metadata that captures the device's folding angle and state, providing a comprehensive representation of the content's creation context. This metadata facilitates a playback experience that can visually replicate the original geometric configuration of the device, enhancing the user's understanding and viewing experience. The system further provides guidance for users to adjust the foldable device to match the recorded folding angle, ensuring an accurate and immersive playback that reflects the content's original creation environment. Other advantages will be described below. Still others will be obvious to those of ordinary skill in the art having the benefit of this disclosure.

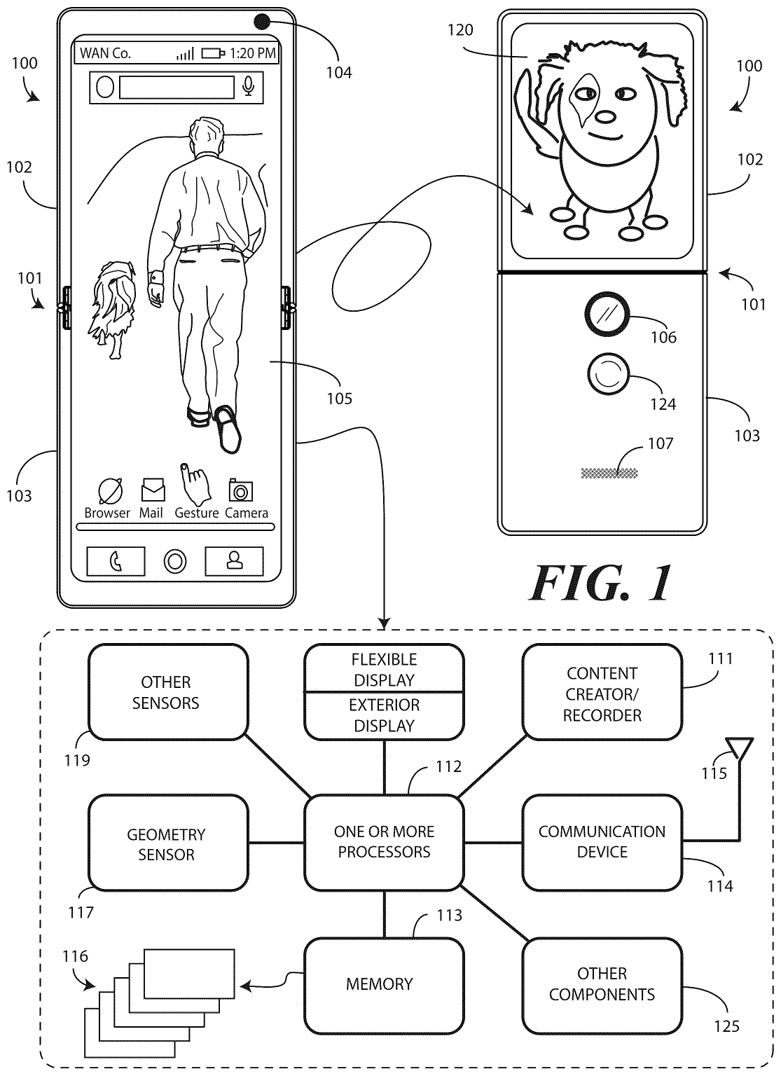

Turning now to FIG. 1, illustrated therein is one explanatory electronic device 100 configured in accordance with one or more embodiments of the disclosure. The electronic device 100 of FIG. 1 is a portable electronic device. For illustrative purposes, the electronic device 100 is shown as a smartphone. However, the electronic device 100 could be any number of other devices as well, including tablet computers, gaming devices, multimedia players, and so forth. Still other types of electronic devices can be configured in accordance with embodiments of the disclosure as will be readily appreciated by those of ordinary skill in the art having the benefit of this disclosure.

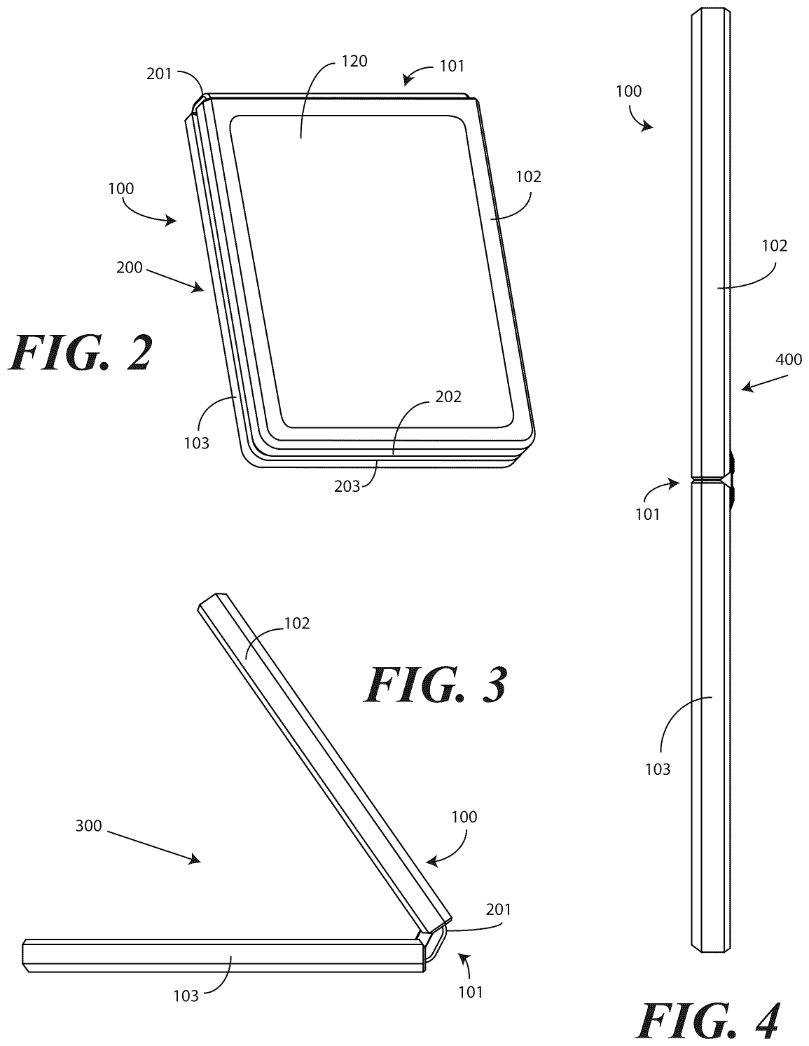

The electronic device 100 includes a first device housing 102 and a second device housing 103. In one or more embodiments, a hinge 101 couples the first device housing 102 to the second device housing 103. In one or more embodiments, the first device housing 102 is selectively pivotable about the hinge 101 relative to the second device housing 103. For example, in one or more embodiments the first device housing 102 is selectively pivotable about the hinge 101 between a closed position, shown and described below with reference to FIG. 2, a partially open position, shown and described below with reference to FIG. 3, and an open position, shown and described below with reference to FIG. 4.

In one or more embodiments the first device housing 102 and the second device housing 103 are manufactured from a rigid material such as a rigid thermoplastic, metal, or composite material, although other materials can be used. Still other constructs will be obvious to those of ordinary skill in the art having the benefit of this disclosure. In the illustrative embodiment of FIG. 1, the electronic device 100 includes a single hinge 101. However, in other embodiments two or more hinges can be incorporated into the electronic device 100 to allow it to be folded in multiple locations.

While the illustrative electronic device 100 of FIG. 1 includes a hinge 101, embodiments of the disclosure are not so limited. In other embodiments, electronic devices configured in accordance with embodiments of the disclosure will not include a hinge 101. Illustrating by example, the electronic device 100 may include a flexible device housing, or the first device housing and second device housing can each comprise flexible device housings. A single device housing, for instance, can be manufactured from bendable materials. In still other embodiments, the electronic device 100 can be bendable via a combination of hinge components and non-hinge components.

Accordingly, in another embodiment the electronic device 100 of FIG. 1 includes a single housing. In one or more embodiments, that housing is flexible. In one embodiment, the housing may be manufactured from a malleable, bendable, or physically deformable material such as a flexible thermoplastic, flexible composite material, flexible fiber material, flexible metal, organic or inorganic textile or polymer material, or other materials. The housing could be formed from a single flexible housing member or from multiple flexible housing members.

In other embodiments, the housing could be a composite of multiple components. For instance, in another embodiment the housing could be a combination of rigid segments connected by hinges or flexible materials. Still other constructs will be obvious to those of ordinary skill in the art having the benefit of this disclosure.

The illustrative electronic device 100 of FIG. 1 includes multiple displays. A first display 105, also referred to as the interior display or the rear-facing display, is concealed when the first device housing 102 is pivoted about the hinge 101 relative to the second device housing 103 to a closed position. For example, the first display 105 is concealed in FIG. 2 below. This first display 105 is then revealed when the first device housing 102 is pivoted about the hinge 101 relative to the second device housing 103 from the closed position to an axially displaced open position. Thus, the first display 105 is revealed as the electronic device 100 transitions from the closed position of FIG. 2 to the open position of FIG. 4.

In one or more embodiments, the electronic device 100 also includes at least a second display 120. In the illustrative embodiment of FIG. 1, the second display 120 can be referred to as an exterior display, quick view display, or front-facing display, as the second display 120 is exposed both when the first device housing 102 and the second device housing 103 are pivoted about the hinge 101 to the closed position, the axially displaced open position, or any position therebetween. Thus, the second display 120 is exposed both in the axially displaced open position of FIG. 1 and the closed position of FIG. 2. In one or more embodiments, each of the first display 105 and the second display 120 is a high-resolution display.

While shown coupled to the first device housing 102, it should be noted that the second display 120 could be coupled to either of the first device housing 102 or the second device housing 103. In other embodiments, the second display 120 can be coupled to the first device housing 102, while a third display (not shown) is coupled to the second device housing 103. Thus, electronic devices configured in accordance with embodiments of the disclosure can include displays situated at different positions.

As with the second display 120, the first display 105 can also be coupled to either or both of the first device housing 102 or the second device housing 103. In this illustrative embodiment, the first display 105 is coupled to both the first device housing 102 and the second device housing 103 and spans the hinge 101. In other embodiments, the “first” display can be two displays, with one coupled to the first device housing 102 and another coupled to the second device housing 103. In either case, this first display 105 is considered to be an “interior” display because it is concealed when the first device housing 102 and the second device housing 103 are in the closed position.

In one or more embodiments, either or both of first display 105 and second display 120 can be touch-sensitive. Where this is the case, users can deliver user input to one or both of the first display 105 or the second display 120 by delivering touch input from a finger, stylus, or other objects disposed proximately with the first display 105 or the second display 120.

In the illustrative embodiment of FIG. 1, since the first display 105 spans the hinge 101, it is configured to be flexible. For instance, in one embodiment the first display 105 is configured as an organic light emitting diode (OLED) display fabricated on a flexible plastic substrate. This allows the first display 105 to be flexible so as to deform when the first device housing 102 pivots about the hinge 101 relative to the second device housing 103. However, it should be noted that other types of displays would be obvious to those of ordinary skill in the art having the benefit of this disclosure. In other embodiments conventional, rigid displays can be disposed to either side of the hinge rather than using a flexible display.

In one or more embodiments, the first display 105 is configured as an OLED constructed on flexible plastic substrates to allow the first display 105 to bend in accordance with various bending radii. For example, some embodiments allow bending radii of between thirty and six hundred millimeters to provide a bendable display. Other substrates allow bending radii of around five millimeters to provide a display that is foldable through active bending. Other displays can be configured to accommodate both bends and folds. In one or more embodiments the first display 105 may be formed from multiple layers of flexible material such as flexible sheets of polymer or other materials.

In this illustrative embodiment, the first display 105 is coupled to the first device housing 102 and the second device housing 103. Accordingly, the first display 105 spans the hinge 101 in this embodiment. In one or more embodiments, the first display 105 can instead be coupled to one, or two, spring-loaded, slidable trays that situate within one or both of the first device housing 102 and the second device housing 103. The use of one or two slidable trays advantageously allows the first display 105 to be placed in tension when the electronic device 100 is in the open position. This causes the first display 105 to be flat, rather than wavy due to mechanical memory effects, when the electronic device 100 is in the open position.

Features can be incorporated into the first device housing 102 and/or the second device housing 103. Examples of such features include imager 106, which in this embodiment is an exterior or front facing imager. The imager 106, which can be any number of types of image capture devices, has its lens situated such that it is directed away from a user who is holding the electronic device 100 and facing the first display 105. This allows the imager 106 to receive light directed toward the electronic device 100 from a location in front of the user when the user is holding the electronic device 100 and facing the first display 105.

Instead of, or alternatively in addition to, the imager 106, a second, rear facing imager 104 can be positioned on the interior side of the electronic device 100 to receive light and images directed toward the first display 105. When a user is holding the electronic device 100 and looking at the first display, this second, rear facing imager 104 can be used to take a selfie without turning the electronic device 100 around. While two imagers are shown in the illustrative embodiment of FIG. 1, it should be noted that embodiments of the disclosure can include additional imagers mounted in different positions that can be actuated to capture images from different angles.

Other examples of features that can be incorporated into the first device housing 102 and/or the second device housing 103 include an optional speaker port 107. While shown situated on the exterior of the electronic device 100 in FIG. 1, the optional speaker port 107 could also be placed on the interior side as well. In this illustrative embodiment, a user interface component 124, which may be a button or touch sensitive surface, can also be disposed along the exterior side of the second device housing 103. As noted, any of these features shown being disposed on the exterior side of the electronic device 100 could be located elsewhere, such as on the interior side or minor sides in other embodiments.

A block diagram schematic of the electronic device 100 is also shown in FIG. 1. In one embodiment, the electronic device 100 includes one or more processors 112. In one embodiment, the one or more processors 112 can include an application processor and, optionally, one or more auxiliary processors. One or both of the application processor or the auxiliary processor(s) can include one or more processors. One or both of the application processor or the auxiliary processor(s) can be a microprocessor, a group of processing components, one or more ASICs, programmable logic, or other type of processing device.

The application processor and the auxiliary processor(s) can be operable with the various components of the electronic device 100. Each of the application processor and the auxiliary processor(s) can be configured to process and execute executable software code to perform the various functions of the electronic device 100. A storage device, such as memory 113, can optionally store the executable software code used by the one or more processors 112 during operation.

In one or more embodiments, the electronic device 100 also includes a content creator/recorder 111. In one or more embodiments, the content creator/recorder 111 of FIG. 1 is a versatile component that can be implemented as an application, a hardware module, or a combination of both. This flexibility allows the content creator/recorder 111 to seamlessly integrate with the imagers 104 and 106, as well as the flexible display 105, to create various types of content, including images, videos, screenshot images, and screenshot videos. The content creator/recorder 111 leverages the capabilities of these components to provide a comprehensive content creation experience for the user.

When implemented as an application, the content creator/recorder 111 can comprises software instructions stored as one or more modules 116 for the one or more processors 112 of the electronic device 100. The content creator/recorder 111 can interface with the imagers 104 and 106 to capture high-quality images and videos. For instance, the rear-facing imager 104 can be used to take selfies or capture scenes in front of the user, while the front-facing imager 106 can capture the environment behind the user. The content creator/recorder 111 can also interact with the flexible display 105 to capture screenshot images and videos, providing users with a visual record of their on-screen activities.

As a hardware module, the content creator/recorder 111 can include dedicated circuitry and components designed to handle the processing and storage of captured content. This hardware module can work in conjunction with the imagers 104 and 106 to ensure that images and videos are captured with minimal latency and high fidelity. Additionally, the hardware module can interface with the flexible display 105 to capture screenshot images and videos, ensuring that the recorded content accurately reflects the on-screen activities.

In many cases, the content creator/recorder 111 is a combination of both software and hardware components. This hybrid approach allows the system to leverage the strengths of both implementations, providing a robust and efficient content creation solution. The software application can offer a user-friendly interface and advanced features, while the hardware module can handle the intensive processing tasks, ensuring smooth and high-quality content capture.

Screenshot videos, in particular, are a valuable feature provided by the content creator/recorder 111. These videos capture the dynamic activities occurring on the flexible display 105, allowing users to record their interactions with applications, games, and other on-screen content. To capture a screenshot video, a user can initiate the recording through the content creator/recorder 111 application, which then records the display's content along with any user interactions, such as touch inputs and gestures. This process ensures that the recorded video accurately reflects the user's on-screen activities.

Screenshot videos are useful for a variety of purposes. For instance, they can be used for creating tutorials and instructional content, allowing users to demonstrate how to use specific applications or features on the device. They are also valuable for troubleshooting and technical support, as users can record and share videos of issues they encounter, providing support teams with a clear understanding of the problem. Additionally, screenshot videos are popular among gamers and content creators who want to share their gameplay experiences or create engaging content for their audiences.

Overall, the content creator/recorder 111 of FIG. 1, whether implemented as an application, hardware module, or a combination thereof, plays an important role in enabling users to create a wide range of content on their foldable devices. By leveraging the capabilities of the imagers 104 and 106 and the flexible display 105, the content creator/recorder 111 provides a comprehensive and versatile content creation solution that enhances the user experience.

In one or more embodiments, the electronic device 100 can also include one or more sensors 119 that are operable with the one or more processors 112. Illustrating by example, one of the one or more sensors 119 that could be employed is a proximity sensor, which measures the distance between the user's face and the electronic device 100. Another sensor 119 that can be utilized is an accelerometer, which detects the orientation and movement of the electronic device 100. In addition to these sensors 119, a gyroscope can measure the device's angular velocity and rotation.

The one or more sensors 119 can also include depth-sensing cameras or infrared sensors. These technologies can capture the user's position in three-dimensional space, allowing for more precise tracking of their movements and gaze direction. Furthermore, the one or more sensors 119 can employ advanced facial recognition algorithms to identify the user's face and track their eye movements.

In this illustrative embodiment, the electronic device 100 also includes a communication circuit 114 that can be configured for wired or wireless communication with one or more other devices or networks. The networks can include a wide area network, a local area network, and/or personal area network. The communication circuit 114 may also utilize wireless technology for communication, such as, but are not limited to, peer-to-peer or ad hoc communications, and other forms of wireless communication such as infrared technology. The communication circuit 114 can include wireless communication circuitry, one of a receiver, a transmitter, or transceiver, and one or more antennas 115.

In one embodiment, the one or more processors 112 can be responsible for performing the primary functions of the electronic device 100. For example, in one embodiment the one or more processors 112 comprise one or more circuits operable with one or more user interface devices, which can include the display 105, to present content offerings including images, video, or other presentation information to a user. The executable software code used by the one or more processors 112 can be configured as one or more modules 116 that are operable with the one or more processors 112. Such modules 116 can store instructions, control algorithms, logic steps, and so forth.

In one embodiment, the one or more processors 112 are responsible for running the operating system environment of the electronic device 100. The operating system environment can include a kernel and one or more drivers, and an application service layer, and an application layer. The operating system environment can be configured as executable code operating on one or more processors or control circuits of the electronic device 100. The application layer can be responsible for executing application service modules. The applications of the application layer can be configured as clients of the application service layer to communicate with services through application program interfaces (APIs), messages, events, or other inter-process communication interfaces. Where auxiliary processors are used, they can be used to execute input/output functions, actuate user feedback devices, and so forth.

In one embodiment, the electronic device 100 includes one or more geometry sensors 117, operable with the one or more processors 112, to detect a particular geometry, geometric form factor, or deformation state of the electronic device 100. Illustrating by example, in one or more embodiments the one or more geometry sensors 117 can detect a bending operation that causes the first device housing 102 to pivot about the hinge 101 relative to the second device housing 103, thereby transforming the electronic device 100 into a deformed geometry, such as that shown in FIGS. 2-3.

In one embodiment, the geometry sensors 117 comprise passive resistive devices manufactured from a material with an impedance that changes when the material is bent, deformed, or flexed. By detecting changes in the impedance as a function of resistance, the one or more processors 112 can use the one or more geometry sensors 117 to detect bending of the first device housing 102 about the hinge 101 relative to the second device housing 103.

In one or more embodiments, each geometry sensor 117 comprises a bi-directional flex sensor that can detect flexing or bending in two directions. In one embodiment, the one or more geometry sensors 117 have an impedance that increases in an amount that is proportional with the amount it is deformed or bent. Other types of geometry sensors 117 will be obvious to those of ordinary skill in the art having the benefit of this disclosure.

In one embodiment, the one or more processors 112 may generate commands or execute control operations based on information received from the various sensors, including the one or more geometry sensors 117, the content creator/recorder 111, or sensors 119. Illustrating by example, in one or more embodiments the one or more processors 112

As described above, in one or more embodiments the first device housing 102 is pivotable about a hinge relative to the second device housing 103. In one or more embodiments, the first device housing 102 and the second device housing 103 are manufactured from a rigid material such as a rigid thermoplastic, metal, or composite material. The first device housing 102 is selectively pivotable about the hinge 101 between a closed position and an axially displaced open position. The first device housing 102 and the second device housing 103, when in a closed position, have front surfaces that abut each other, conceal the flexible display 105. The first device housing 102, when pivoted to an open position, reveals the flexible display 105 which is coupled to both the first device housing 102 and the second device housing 103 and spans the hinge 101 in one or more embodiments.

The second device housing 103, in conjunction with the first device housing 102, forms part of the deformable device housing of the electronic device. The second device housing 103 is configured to pivot relative to the first device housing 102 about the hinge 101. The second device housing 103, along with the first device housing 102, supports at least one display, which in this case is the flexible display 105. The second device housing 103, when in the closed position, aligns with the first device housing 102 to protect the flexible display 105 and to facilitate portability and protection of the internal components of the electronic device.

The hinge 101 couples the first device housing 102 to the second device housing 103 and allows for the selective pivoting of the first device housing 102 relative to the second device housing 103. The hinge 101, in one or more embodiments, is configured as a friction hinge, which includes frictional elements that enable the electronic device to retain a set position between the closed position and the axially displaced open position. The hinge 101 facilitates the transformation of the electronic device into various geometric configurations, including a partially open position that resembles a laptop geometric form factor.

In one or more embodiments, the flexible display 105 is coupled to both the first device housing 102 and the second device housing 103 and spans the hinge 101. The flexible display 105 is concealed when the electronic device is in a closed position and is revealed as the electronic device transitions to an axially displaced open position. In one or more embodiments, the flexible display 105 is configured as an organic light emitting diode display constructed on flexible plastic substrates, allowing the flexible display 105 to bend in accordance with the pivoting action of the first device housing 102 about the hinge 101. In one or more embodiments, the flexible display 105 is capable of presenting content and is touch-sensitive, allowing users to interact with the electronic device through touch input.

The one or more processors 112 are operable with the one or more sensors to present content identifying a deformed geometry at which an originating electronic device was configured when creating the content with visual indicia identifying the deformed geometry. The one or more processors 112 are responsible for executing the primary functions of the electronic device, including running the operating system environment, processing user input, and managing the presentation of content on the flexible display 105. The one or more processors 112 generate commands or execute control operations based on information received from the one or more sensors 119 and the geometry sensors 117.

The one or more sensors 119 are operable to detect a geometric configuration of the deformable device housing. These sensors 119 may include a variety of sensing technologies such as proximity sensors, accelerometers, gyroscopes, depth-sensing cameras, and infrared sensors. The one or more sensors 119 work in conjunction with the one or more processors 112 to monitor the geometric configuration of the electronic device and to facilitate the presentation of content with visual indicia that reflect the deformed geometry at which the content was originally created. The one or more sensors 119 enable the electronic device to dynamically adjust the content presentation based on the detected geometric configuration, enhancing the user experience by providing a seamless transition between different device states.

The one or more processors 112 may also generate commands or execute control operations based upon information received from a combination of the one or more geometry sensors 117, the content creator/recorder 111, or the one or more sensors 119. Alternatively, the one or more processors 112 can generate commands or execute control operations based upon information received from the one or more geometry sensors 117 or the content creator/recorder 111 alone. Moreover, the one or more processors 112 may process the received information alone or in combination with other data, such as the information stored in the memory 113.

The one or more sensors 119 may include a microphone, an earpiece speaker, a second loudspeaker (disposed beneath speaker port 107), and a user interface component such as a button or touch-sensitive surface. The one or more sensors 119 may also include key selection sensors, proximity sensors, a touch pad sensor, a touch screen sensor, a capacitive touch sensor, a light sensor, and one or more switches. Touch sensors may be used to indicate whether any of the user actuation targets present on the display 105 or display 120 are being actuated. Alternatively, touch sensors disposed in the electronic device 100 can be used to determine whether the electronic device 100 is being touched at side edges or major faces of the first device housing 102 or the second device housing 103. The touch sensors can include surface and/or housing capacitive sensors in one embodiment. The one or more sensors 119 can also include audio sensors and video sensors (such as a camera).

The one or more sensors 119 can also include motion detectors, such as one or more accelerometers or gyroscopes. For example, an accelerometer may be embedded in the electronic circuitry of the electronic device 100 to show vertical orientation, constant tilt and/or whether the electronic device 100 is stationary. A gyroscope can be used in a similar fashion.

Other components 125 operable with the one or more processors 112 can include output components such as video outputs, audio outputs, and/or mechanical outputs. Examples of output components include audio outputs such as speaker port 107, earpiece speaker, or other alarms and/or buzzers and/or a mechanical output component such as vibrating or motion-based mechanisms. Still other components will be obvious to those of ordinary skill in the art having the benefit of this disclosure.

It is to be understood that FIG. 1 is provided for illustrative purposes only and for illustrating components of one electronic device 100 in accordance with embodiments of the disclosure and is not intended to be a complete schematic diagram of the various components required for an electronic device. Therefore, other electronic devices in accordance with embodiments of the disclosure may include various other components not shown in FIG. 1 or may include a combination of two or more components or a division of a particular component into two or more separate components, and still be within the scope of the present disclosure.

Turning now to FIG. 2, illustrated therein is the electronic device 100 in a closed state. In this state, the first device housing 102 has been pivoted about the hinge 101 toward the second device housing 103 to a closed position 200. When in the closed position 200, a front surface 202 of the first device housing 102 abuts a front surface 203 of the second device housing 103. Additionally, in this illustrative embodiment, a hinge housing 201 comprising the hinge 101 is revealed when the electronic device 100 is in the closed position 200. In other embodiments, the hinge housing 201 will remain concealed when the first device housing 102 pivots about the hinge 101 relative to the second device housing 103 to the closed position 200. Effectively, in either embodiment, the first device housing 102 and the second device housing 103 are analogous to clam shells that have been shut by the clam, thereby giving rise to the “clamshell” style of device. When the clamshell opens, the flexible display (105) is revealed.

In some embodiments, features can be included to further retain the electronic device 100 in the closed position 200. Illustrating by example, in another embodiment, a mechanical latch can be included to retain the first device housing 102 and the second device housing 103 in the closed position 200.

In still another embodiment, magnets can be incorporated into the front surface 202 of the first device housing 102 and the front surface 203 of the second device housing 103. For instance, magnets can be placed in the first device housing 102 and the second device housing 103 to retain the first device housing 102 and the second device housing 103 in the closed position 200.

In still other embodiments, frictional elements can be incorporated into the hinge 101 to retain the first device housing 102 and the second device housing 103 in a particular position. A stator motor could be integrated into the hinge 101 as well. Still other mechanical structures and devices suitable for retaining the electronic device 100 in the closed position 200 will be obvious to those of ordinary skill in the art having the benefit of this disclosure. As shown, the exterior display 120 is visible and exposed when the electronic device is in the closed position 200.

Turning now to FIG. 3, the electronic device 100 is shown in a geometric form factor defined by a deformed geometry such that the first device housing 102 and the second device housing 103 are between the closed position (200) of FIG. 2 and an axially displaced open position. Where the hinge 101 includes frictional elements, the electronic device 100 may remain in this geometric form factor until a user pivots one of the first device housing 102 or the second device housing 103 about the hinge 101 to another geometric form factor.

The geometric form factor of FIG. 3 is that of a partially open position 300. Specifically, the first device housing 102 is pivoting about the hinge 101 away from the second device housing 103 toward an open position. The open position 300 shown in FIG. 3 can be referred to as a “tent position.” In the side elevation view of FIG. 3, the hinge housing 201 is exposed between the first device housing 102 and the second device housing 103.

Turning now to FIG. 4, illustrated therein is the electronic device 100 in an axially displaced open position 400. In the axially displaced open position 400, the first device housing 102 is rotated about the hinge 101 so as to be axially displaced 180-degrees out of phase with the second device housing 103, thereby revealing the flexible display (105). In this illustrative embodiment, this causes the hinge housing (201) to be concealed within the first device housing 102 and second device housing 103.

In such a configuration, the first device housing 102 and the second device housing 103 effectively define a plane. Since this illustrative embodiment includes a flexible display 105, the flexible display 120 has been elongated into a flat position.

In one or more embodiments, the electronic device 100 of FIGS. 2-4 comprises a deformable device housing defined by the first device housing 102, the second device housing 103, and the hinge 101, that supports at least one display, e.g., the flexible display (105). In one or more embodiments, the electronic device 100 comprises one or more sensors (119) operable to detect a geometric configuration of the deformable device housing. In one or more embodiments, the electronic device 100 comprises one or more processors (112) operable with the one or more sensors.

In one or more embodiments, the one or more processors present content identifying a deformed geometry at which an originating electronic device was configured when creating the content with visual indicia identifying the deformed geometry unless the one or more sensors detect the deformable device housing substantially matching the deformed geometry. In one or more embodiments, the visual indicia depict another electronic device having another first device housing that is pivotable about another hinge relative to another second device housing with the another first device housing pivoted about the another hinge relative to the another second device housing partially between the axially displaced open position and the closed position.

In one or more embodiments, the visual indicia instruct how to transform the deformable device housing to match the deformed geometry. In one or more embodiments, the one or more processors remove the visual indicia when the deformable housing transitions to substantially match the deformed geometry while the content is being presented. In one or more embodiments, the content comprises a screen shot captured by the originating electronic device while the originating electronic device was in a deformed geometric configuration.

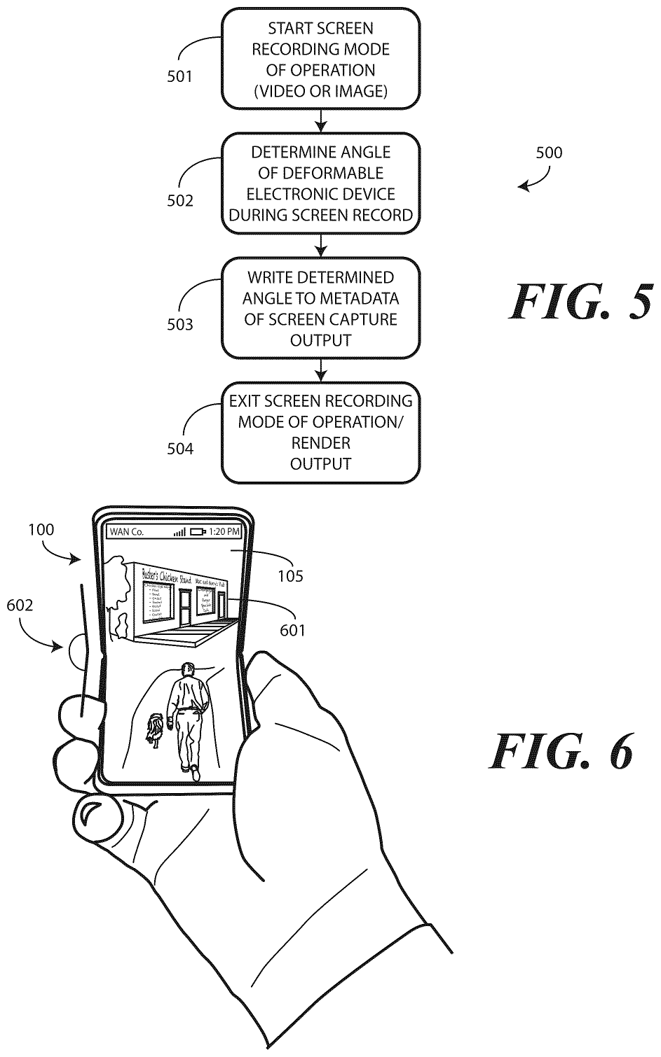

Turning now to FIG. 5, illustrated therein is one explanatory method 500 suitable for use with the electronic device (100) of FIGS. 1-4. While the method 500 of FIG. 5 is for creating content, in one or more embodiments the content created by the method 500 thereafter facilitates presenting, by a user interface, content with visible indicia indicating an originating electronic device geometric configuration at which the content was created unless a geometric configuration of the electronic device substantially matches the originating electronic device geometric configuration.

FIG. 5 illustrates one explanatory method 500 for creating content in an originating electronic device. The method begins at step 501, where the electronic device enters a screen recording mode of operation, which may involve capturing either video or image content. In one or more embodiments, this step is initiated by receiving user input, which can be provided through various user interface mechanisms such as a touch-sensitive display, a physical button, or a voice command.

Once the screen recording mode is activated, the method 500 proceeds to step 502, where a geometry sensor of the originating electronic device determines the angle of the originating electronic device while creating content. In one or more embodiments, this step involves utilizing one or more geometry sensors to detect the current geometric form factor of the device, which may include various states of deformation such as folded, partially folded, or flat configurations. The determination of the geometric form factor affects the context in which the content is being created and may influence the presentation of the content during subsequent playback.

At step 503, the method 500 involves associating the geometric form factor with the content created at step 502. In one or more embodiments, this step 503 comprises writing the determined angle to the metadata of the screen capture output. This step 503 ensures that the geometric form factor information is preserved alongside the content itself, allowing for accurate reconstruction of the device's state during content creation when the content is later accessed or shared. In one or more embodiments, the metadata may include not only the initial geometric form factor but also any changes in the form factor that occur during the content creation process.

The method 500 then proceeds to step 504, where the electronic device exits the content creation mode of operation and renders the output. In one or more embodiments, this step 504 finalizes the content creation process, resulting in a content file that is stored in the device's memory. The rendered output includes the content captured during step 501, along with the associated metadata written in step 503. The output can then be accessed for playback, editing, or sharing, with the metadata enabling an enhanced viewing experience that reflects the original conditions under which the content was created.

The method 500 can include alternate techniques for performing the various steps as well. For instance, the determination of the geometric form factor at step 502 could be achieved through a combination of sensors, including accelerometers, gyroscopes, and proximity sensors, each providing data that contributes to an accurate assessment of the device's angle and state. Similarly, the writing of metadata at step 503 could involve different data encoding formats or standards to ensure compatibility with various playback devices and platforms. Other variations in the method 500 will be obvious to those of ordinary skill in the art having the benefit of this disclosure.

Turning now to FIG. 6, illustrated therein is the electronic device 100 of FIG. 1 performing the method (500) of FIG. 5. As shown in this figure, the first device housing 102 is pivoted relative to the second device housing 102 partially between the axially displaced open position and the closed position while a screenshot video recording 601 of hungry diners heading to Buster's Chicken Shack for some of Buster's world-famous chicken. In this illustrative example, one or more sensors of the electronic device 100 determine the angle 602 between the first device housing 102 and the second device housing 103 while the screenshot video recording 601 is being captured. As described above, in one or more embodiments, this angle 602—and any changes in the angle 602 that may occur while the screenshot video recording 601 is being created—can be associated with the screenshot video recording 601. Illustrating by example, the angle 602 can be written to metadata of the screenshot video recording 601 in one or more embodiments.

In this illustrative example, the screenshot video recording 601 captures the excitement and anticipation of the diners as they make their way to the Buster's, showcasing the dynamic interactions and expressions on their faces. The screenshot video recording 601 begins with the diners feeling their craving for Buster's chicken, highlighting the unique flavors and crispy texture that make it a favorite among locals.

As the screenshot video recording 601 progresses, the diners think of their personal experiences and fond memories associated with Buster's Chicken Shack. Their thoughts reminisce about their first visit to the restaurant, describing the mouth-watering aroma that greeted them as they walked through the door. The screenshot video recording 601 captures their animated delighted facial expression, emphasizing the sense of nostalgia and joy that Buster's chicken brings to them.

The screenshot video recording 601 screenshot recording also includes scenes of the diners arriving at Buster's Chicken Shack, with video imagery depicted in the screenshot video recording 601 capturing the vibrant atmosphere and bustling activity inside the restaurant. The diners eagerly place their order, and the screenshot video recording 601 showcases the preparation process, highlighting the care and attention to detail that goes into making each piece of chicken. The screenshot video recording 601 concludes with the diners savoring their meal, their expressions of satisfaction and delight underscoring why Buster's Chicken Shack holds a special place in their hearts.

This narrative not only provides a vivid depiction of the diners' journey to Buster's Chicken Shack but also explains why they love the restaurant so much. The combination of flavorful, crispy chicken, the welcoming atmosphere, and the cherished memories associated with each visit make Buster's Chicken Shack a beloved destination for these two hungry diners.

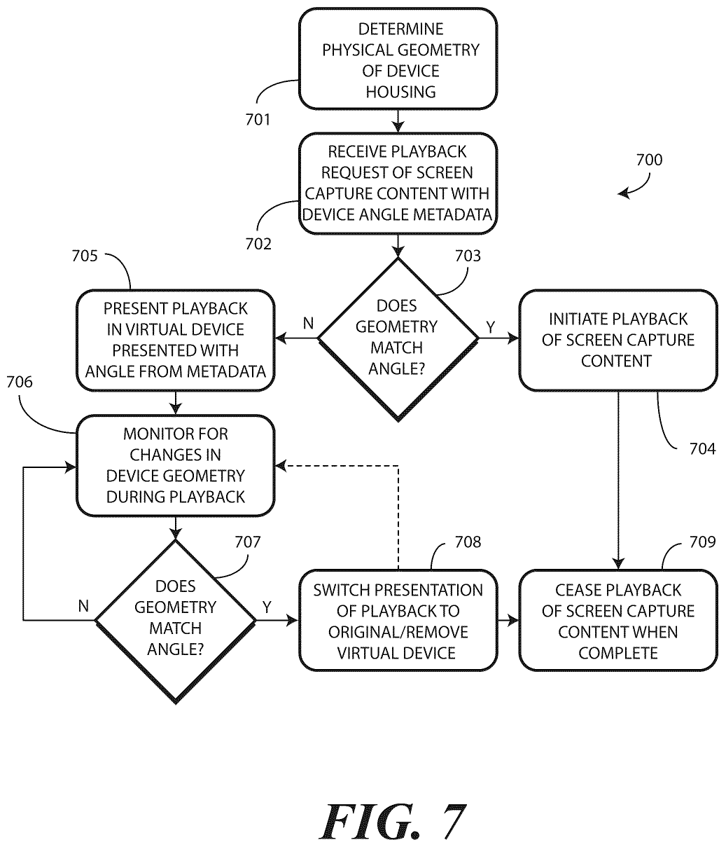

Turning now to FIG. 7, illustrated therein is another method 700 for presenting a screenshot video recording, one example of which is the screenshot video recording (601) captured in FIG. 6. In one or more embodiments, the method 700 presents, by a user interface, content such as the screenshot video recording (601) with visible indicia indicating an originating electronic device geometric configuration at which the content was created. In one or more embodiments, these visible indicia are presented unless a geometric configuration of the electronic device substantially matches the originating electronic device geometric configuration.

FIG. 7 shows a flowchart implementing a method 700 for managing the playback of screen capture content on an electronic device with a deformable housing, wherein the content includes metadata indicating the geometric configuration of the device at the time of content creation. The method begins at step 701, where the physical geometry of the device housing is determined. In one or more embodiments, the electronic device is equipped with sensors or mechanisms capable of ascertaining the current geometric configuration at step 701, which may include, but is not limited to, a folded, partially folded, or flat state. In one or more embodiments, the geometric configuration comprises a deformed geometric configuration where a first device housing portion is skew relative to a second device housing portion.

Alternative techniques for determining the physical geometry at step 701 may involve the use of one or more geometry sensors, such as accelerometers, gyroscopes, or flex sensors, which can detect the angle and degree of deformation of the device housing. These sensors may provide real-time data on the device's geometric configuration, which can be processed by the device's processors to establish the current state of the device.

At step 702, the method 700 receives a playback request for screen capture content that includes metadata with device angle information. In one or more embodiments, step 702 comprises receiving, by a user interface of the electronic device, user input requesting a presentation of content written to its metadata at least one geometric configuration of an originating electronic device occurring when the content was created. As described above with reference to FIGS. 5-6, in one or more embodiments the content was previously recorded with metadata that captures the geometric configuration of the originating electronic device during the screen capture process, allowing for an accurate reconstruction of the device's state during content creation when the content is later accessed or shared.

At decision 703, one or more sensors of the electronic device determine whether the current geometry of the device matches the angle indicated in the metadata. Said differently, in one or more embodiments decision 703 determines whether the geometric form factor of the electronic device presenting the content is the same or substantially the same as the geometric form factor of the originating electronic device when the content was created. In one or more embodiments, if the geometry matches, as determined by a positive outcome at decision 703, the method 700 initiates playback of the screen capture content at step 704. This step 704 results in the content being presented in a manner that reflects the original conditions under which the content was created, without the need for additional visual indicia.

If the geometry does not match, as determined by a negative outcome at decision 703, the method 700 presents the playback differently at step 705. In one or more embodiments, step 705 comprises presenting, by a user interface, the content with visible indicia indicating an originating electronic device geometric configuration at which the content was created unless a geometric configuration of the electronic device substantially matches the originating electronic device geometric configuration.

Illustrating by example, in one or more embodiments the visual indicia presented at step 705 depicts an originating electronic device. In one or more embodiments, step 705 results in the content being presented on a display of the originating electronic device depicted in the visual indicia. In one or more embodiments, the visible indicia depict the originating electronic device in a partially deformed geometry defined by the originating electronic device geometric configuration. In one or more embodiments, the visible indicia depict the originating electronic device having a first device housing that is pivotable about a hinge relative to a second device housing between an axially displaced open position and a closed position.

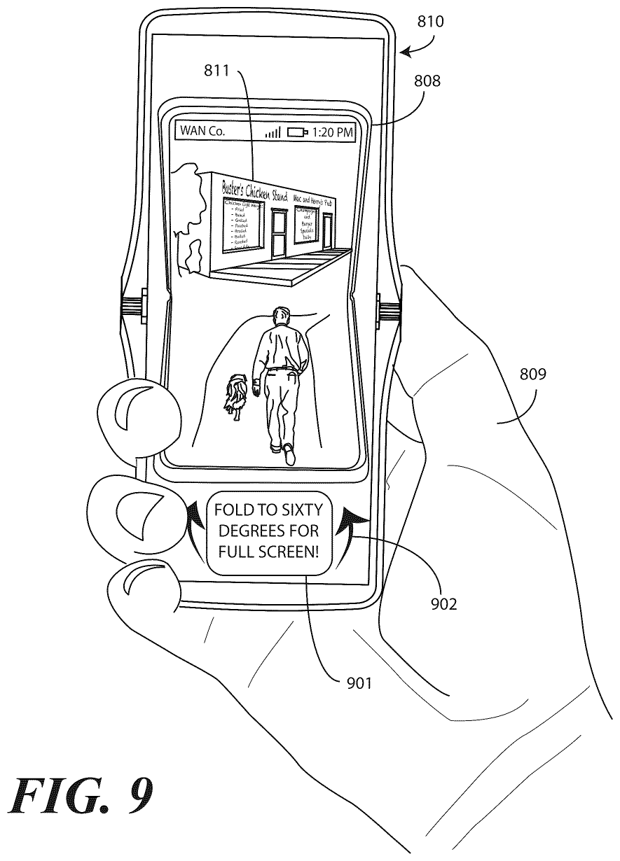

In one or more embodiments, the visible indicia further depict the originating electronic device with the first device housing pivoted relative about the hinge relative to the second device housing partially between the axially displaced open position and the closed position. In one or more embodiments, the visible indicia comprise instructions for transitioning the electronic device to the originating electronic device geometric configuration. Other examples of visible indicia will be described below with reference to FIG. 9. Still others will be obvious to those of ordinary skill in the art having the benefit of this disclosure. In one or more embodiments, step 705 involves displaying visual indicia or a three-dimensional model that represents the device in the geometric configuration indicated by the metadata, providing the user with a visual guide to the original recording conditions.

During playback, the method 700 continuously monitors for changes in the device geometry at step 706. In one or more embodiments, step 706 comprises monitoring, using one or more sensors, changes in the geometric configuration of the electronic device while the content is presented.

If a change is detected that results in the device's geometry matching the angle indicated in the metadata, as determined by a positive outcome at step 707, the method 700 switches the presentation of the playback to the original or removes the visible indicia at step 708. Said differently, in one or more embodiments step 708 comprises removing, by the user interface, the visible indicia when the changes in the geometric configuration cause the geometric configuration to substantially match the originating electronic device geometric configuration.

This step 708 suggests that once the device is adjusted to match the recorded angle, the visual indicia or three-dimensional model is removed, and the content is displayed in full screen, offering an immersive viewing experience that matches the original recording conditions. Where the originating electronic device geometric configuration comprises multiple geometric configurations that occurred in an originating electronic device while the content was created, step 708 may selectively remove the visible indicia only when the electronic device matches one or more of the geometric configurations during presentation of the content.

Of course, for a non-deformable device, step 708 would be omitted unless the content was created by the originating electronic device while in the axially displaced open position. Thus, in one or more embodiments the visible indicia indicating the originating electronic device geometric configuration at which the content was created is always presented at step 705 with the content when a device housing of the electronic device is non-deformable.

If the geometry continues to not match the angle, as determined by a negative outcome at step 707, the method continues to monitor for changes in device geometry during playback. The method ceases playback of the screen capture content when complete at step 709, concluding the playback process.

Thus, as illustrated and described the method 700 of FIG. 7 receives, by a user interface at step 702, user input requesting a presentation of content having written to its metadata at least one geometric configuration of an originating electronic device occurring when the content was created. The method 700 presents, by one or more processors on the user interface at step 705, the content within an electronic device depiction having the at least one geometric configuration until the electronic device transitions to the at least one geometric configuration. In one or more embodiments, the at least one geometric configuration comprising a deformed geometric configuration where a first device housing portion is skew relative to a second device housing portion. In one or more embodiments, the presentation of the content on the user interface causes the content to appear on a display of the originating electronic device.

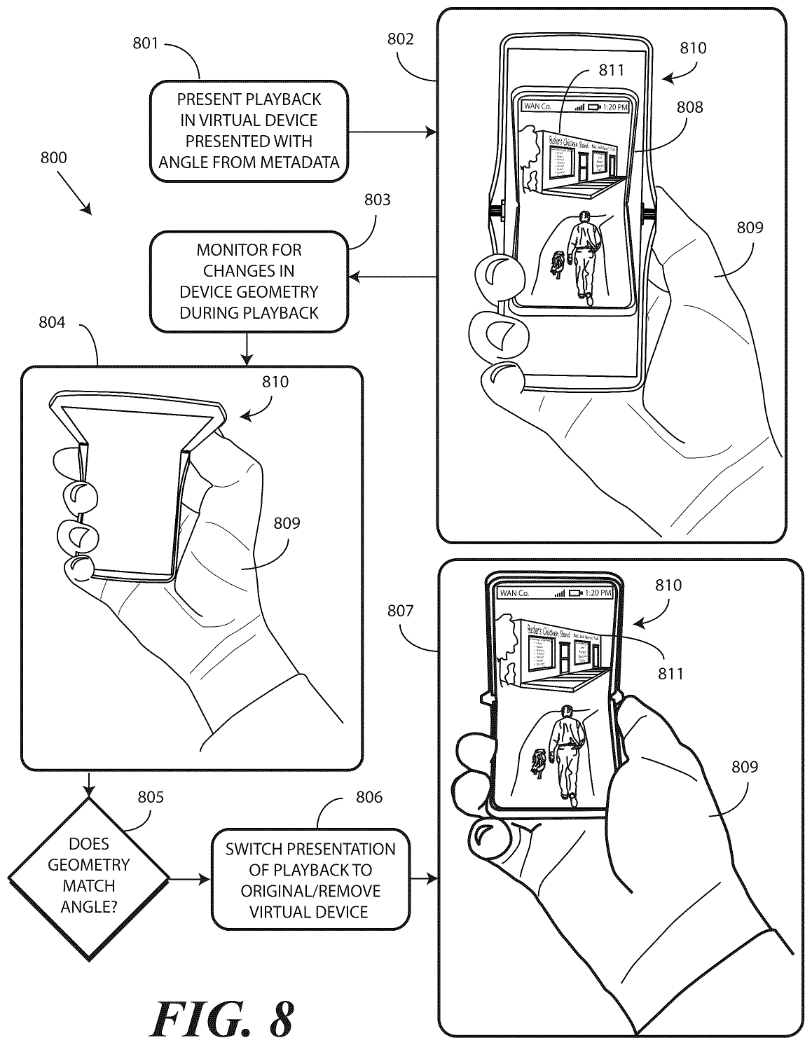

Turning now to FIG. 8, illustrated therein is another method 800 that illustrates the various steps of the method (700) of FIG. 7 with a use case where the content 811 captured using the method (500) of FIG. 5 is being presented to a user 809 using an electronic device 810 configured in accordance with one or more embodiments of the disclosure. Beginning at step 801, one or more processors of the electronic device 810 present, using a user interface represented at step 802 as the display of the electronic device 810, content 811 with visible indicia 808 indicating an originating electronic device geometric configuration at which the content 811 was created.

As shown at step 802, a user 809 is viewing the content 811 with the presenting electronic device 810 in an axially displaced open position. However, the originating electronic device geometric configuration was in a laptop geometric form factor. Accordingly, at step 802 the content 811 is presented with visible indicia 808 depicting the originating electronic device and indicating the laptop geometric form factor. Also shown in step 802 is the fact that the content 811 is presented on the display of the depiction of the originating electronic device, with the originating electronic device being depicted in the partially deformed geometry defined by the originating electronic device geometric configuration when the content 811 was created. This results in the visible indicia 808 of step 802 showing the originating electronic device having a first device housing that is pivotable about a hinge relative to a second device housing between an axially displaced open position and a closed position, with the first device housing pivoted relative to the second device housing partially between the axially displaced open position and the closed position.

Turning briefly to FIG. 9, in one or more embodiments the visible indicia 808 can be presented on the electronic device 810 with instructions 901 for the user 809 for transitioning the electronic device 810 to the originating electronic device geometric configuration. Illustrating by example, in this example the instructions 901 say, “fold to sixty degrees for full screen!” In this illustrative embodiment, the instructions 901 are accompanied by pictorial indications 902 instructing how the first device housing and second device housing of the electronic device 810 should be deformed to reach a full screen viewing experience. In other embodiments, the pictorial indications 902 will be omitted.

Thus, in this illustrative example FIG. 9 shows an embodiment of an electronic device 810 being held by a user 809, displaying content 811 with visible indicia 808. The electronic device 810 presents the content 811 on the display, which includes visual instructions 901 for adjusting the device to a specific geometric configuration. The visible indicia 808 provide guidance to the user, suggesting an adjustment of the electronic device 810 to a sixty-degree angle for an optimal full-screen viewing experience, as indicated by the textual instruction “fold to sixty degrees for full screen!” Additionally, pictorial indications 902 accompany the textual instruction, further assisting the user in achieving the desired geometric configuration for viewing the content 811.

The electronic device 810 displays the content 811 within a depiction of an originating electronic device, which is shown in a partially deformed geometry. This depiction serves to inform the user 809 of the original geometric configuration of the device at the time the content 811 was created. The visible indicia 808, including both textual instructions 901 and pictorial indications 902, are designed to enhance the user's interaction with the electronic device 810 by providing a clear and intuitive guide for adjusting the device to match the originating geometric configuration, thereby ensuring a viewing experience that is consistent with the conditions under which the content 811 was originally created.

Turning now back to FIG. 8, at step 803 one or more sensors of the electronic device 810 monitor changes in the geometric configuration of the electronic device 810 while the content 811 is being presented. As shown at step 804, the user 809 heeds the instructions (901) provided and deforms the electronic device 810 to the geometric configuration of the originating electronic device. Decision 805 detects this, with step 806 thereafter removing the visible indicia 808 from the display of the electronic device 810 when the changes in the geometric configuration of the electronic device 810 cause the geometric configuration to substantially match the originating electronic device geometric configuration. Thus, as shown at step 807, the content 811 is presented in full screen view so that the user 809 can enjoy the content just as the content creator had envisioned.

Thus, as illustrated and described, FIG. 8 illustrates one embodiment of a method 800 for managing the presentation of playback content on an electronic device 810. The method 800 includes presenting playback in a virtual device presented with an angle from metadata at step 801, monitoring for changes in device geometry during playback at step 803, determining if the geometry matches the angle at decision 805, and switching the presentation of playback to the original or removing the virtual device at step 806 once the geometric configuration of the electronic device 810 matches the geometric configuration of the originating electronic device. The electronic device 810 displays content with visible indicia 808, which may include instructions (901) or a three-dimensional model that represents the device in the geometric configuration indicated by the metadata.

At step 801, the electronic device 810 presents playback content 811 within a depiction of a virtual device, which includes visible indicia 808 that indicate the geometric configuration of the originating electronic device at the time the content 811 was created. This depiction is based on the angle information stored in the metadata of the content 811 in one or more embodiments. The electronic device 810 is held by a user 809, who views the content on the display of the electronic device 810.

At step 803, the electronic device 810 monitors for any changes in the electronic device's geometric configuration during the playback of the content 811. This monitoring can be performed by sensors within the electronic device 810, which can detect changes in the angle or position of the device as the user 809 interacts with the electronic device 810.

At decision 805, a determination is made as to whether the current geometric configuration of the electronic device 810 matches the angle indicated in the metadata. If the geometry matches, the method proceeds to step 806, where the presentation of the playback content is switched back to the original configuration, and the visible indicia 808 are removed. This allows the user 809 to view the content in full screen without the virtual device depiction, provided the electronic device 810 is adjusted to match the recorded angle.

At step 806, upon matching the geometric configuration, the electronic device 810 switches the presentation of the playback content to remove the visible indicia 808, resulting in a full-screen display of the content. This transition is depicted in the lower part of FIG. 8, where the user 809 has adjusted the electronic device 810 to match the originating geometric configuration, and the content is now presented without the virtual device depiction.

The method 800 of FIG. 8 offers several advantages that enhance the user experience when interacting with foldable devices. One significant advantage is the ability to provide a contextually accurate playback experience by ensuring that the content is presented in the same geometric configuration as when it was originally created. This is achieved through the use of visible indicia 808, which guide the user 809 in adjusting the electronic device 810 to match the recorded angle. By doing so, the method 800 ensures that the playback experience is immersive and true to the original recording conditions.

Another advantage of the method 800 is the dynamic adjustment of the content presentation based on real-time monitoring of the device's geometric configuration. The sensors within the electronic device 810 continuously monitor changes in the device's angle or position during playback. If the device's geometry matches the angle indicated in the metadata, the method 800 switches the presentation to full screen, removing the visible indicia 808. This seamless transition enhances the viewing experience by eliminating distractions and providing a clear and unobstructed view of the content.

The method 800 also addresses the challenge of playing back content on non-foldable devices. By presenting the content within a depiction of a virtual device, the method 800 ensures that users can still understand the context of the recording, even if their device does not support folding. This visual representation helps users grasp the original geometric configuration of the device at the time the content was created, thereby improving the overall usability and viewing experience of screen recordings on foldable devices.

Furthermore, the method 800 enhances user interaction by providing clear and intuitive instructions (901) for adjusting the device to match the originating geometric configuration. The visible indicia 808, including textual instructions and pictorial indications, guide the user in achieving the desired angle for an optimal viewing experience. This feature is particularly useful for applications that behave differently based on the device's folding state, preventing confusion and ensuring that users can fully enjoy the content as intended.

Overall, the method 800 of FIG. 8 offers a comprehensive solution for managing the presentation of playback content on foldable devices. By incorporating real-time monitoring, dynamic adjustment, and clear visual guidance, the method significantly improves the user experience, making it easier for users to interact with and enjoy content on their foldable devices. Other advantages will be obvious to those of ordinary skill in the art having the benefit of this disclosure.

Additionally, different embodiments that operate in a similar manner to the method 800 of FIG. 8 will be obvious to those of ordinary skill in the art having the benefit of this disclosure. Illustrating by example, in another embodiment, a foldable device features a dual-screen configuration where the first device housing includes a primary display and the second device housing includes a secondary display, both of which are pivotable about a central hinge. The hinge is designed with a robust locking mechanism that allows the device to maintain a stable angle in laptop mode, providing users with a consistent viewing experience when interacting with content on either screen.

Another embodiment may incorporate a single, continuous display that spans across both the first and second device housings, with the hinge mechanism allowing for a seamless transition between the folded and unfolded states. This continuous display could utilize advanced flexible OLED technology to ensure that the screen does not distort or damage when changing between configurations.

A further embodiment could involve a modular hinge design that allows for the replacement or customization of the hinge's resistance levels, enabling users to personalize the folding experience to their preference. This could include hinges with adjustable tension settings or even smart hinges that automatically adjust to the user's folding habits over time.

In yet another embodiment, the foldable device could be equipped with sensors embedded within the hinge mechanism that precisely measure the folding angle in real-time. These sensors could be linked to software that adjusts the content presentation based on the detected angle, enhancing the user's interaction with the device by providing context-sensitive information or controls.

An additional embodiment might feature a foldable device with a specialized hinge that not only supports various folding angles but also integrates additional functionality, such as wireless charging capabilities when in laptop mode, or built-in speakers that orient sound directionally based on the folding angle to optimize audio output for media consumption.

Lastly, an embodiment could focus on the durability aspect of the foldable device, employing materials such as liquid metal alloys or advanced composites for the hinge construction, which would provide exceptional strength and flexibility, ensuring that the device can withstand repeated folding actions without compromising structural integrity. These examples are illustrative only, as still other embodiments will be obvious to those of ordinary skill in the art having the benefit of this disclosure.

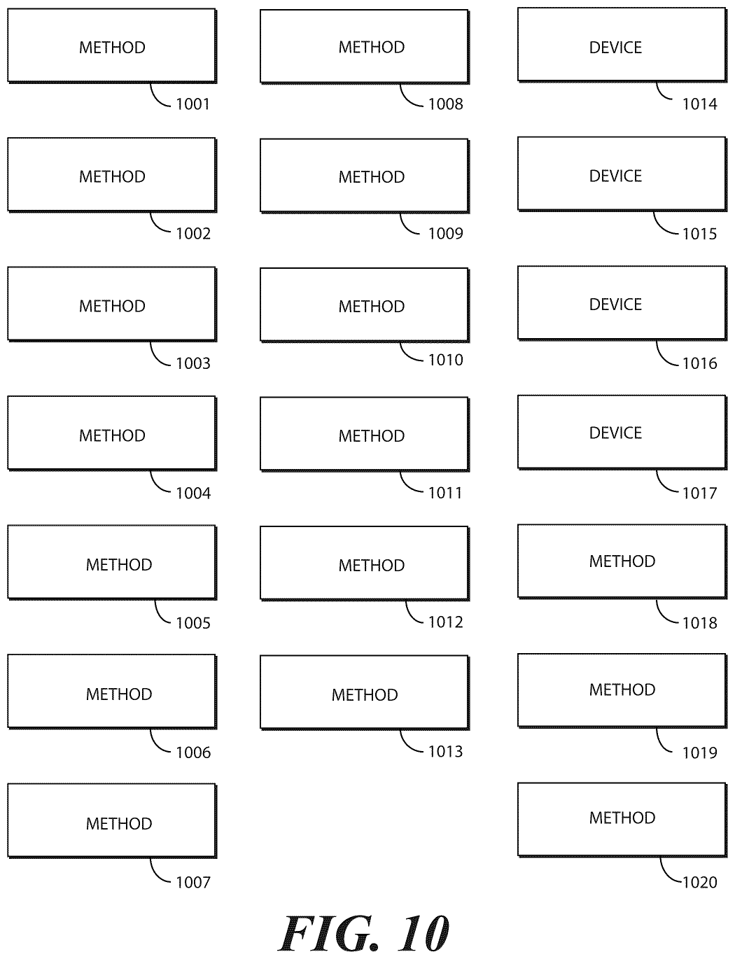

Turning now to FIG. 10, illustrated therein are various embodiments of the disclosure. The embodiments of FIG. 10 are shown as labeled boxes in FIG. 10 due to the fact that the individual components of these embodiments have been illustrated in detail in FIGS. 1-9, which precede FIG. 10. Accordingly, since these items have previously been illustrated and described, their repeated illustration is no longer essential for a proper understanding of these embodiments. Thus, the embodiments are shown as labeled boxes.

At 1001, a method in an electronic device comprises presenting, by a user interface, content with visible indicia indicating an originating electronic device geometric configuration at which the content was created unless a geometric configuration of the electronic device substantially matches the originating electronic device geometric configuration. At 1002, the originating electronic device geometric form factor of 1001 is written to metadata of the content.

At 1003, the visible indicia of 1001 depict an originating electronic device. At 1004, the content of 1003 is presented on a display of the originating electronic device.

At 1005, the visible indicia of 1004 depict the originating electronic device in a partially deformed geometry defined by the originating electronic device geometric configuration. At 1006, the visible indicia of 1005 depict the originating electronic device having a first device housing that is pivotable about a hinge relative to a second device housing between an axially displaced open position and a closed position.

At 1007, the visible indicia of 1006 further depict the originating electronic device with the first device housing pivoted relative about the hinge relative to the second device housing partially between the axially displaced open position and the closed position. At 1008, the visible indicia of 1001 comprise instructions for transitioning the electronic device to the originating electronic device geometric configuration.

At 1009, the method of 1001 further comprises monitoring, using one or more sensors, changes in the geometric configuration of the electronic device while the content is presented. At 1009, the method comprises removing, by the user interface, the visible indicia when the changes in the geometric configuration cause the geometric configuration to substantially match the originating electronic device geometric configuration.

At 1010, the originating electronic device geometric form factor of 1001 comprises multiple geometric configurations that occurred in an originating electronic device while the content was created. At 1011, the visible indicia of 1001 indicate the originating electronic device geometric configuration at which the content was created is always presented with the content when a device housing of the electronic device is non-deformable.

At 1012, an electronic device comprises a deformable device housing supporting at least one display. At 1012, the electronic device comprises one or more sensors operable to detect a geometric configuration of the deformable device housing and one or more processors operable with the one or more sensors. At 1012, the one or more processors present content identifying a deformed geometry at which an originating electronic device was configured when creating the content with visual indicia identifying the deformed geometry unless the one or more sensors detect the deformable device housing substantially matching the deformed geometry.

At 1013, the deformable housing of 1012 comprises a first device housing that is pivotable about a hinge relative a second device housing between an axially displaced open position and a closed position. At 1013, the at least one display comprises a flexible display coupled to the first device housing and the second device housing and spanning the hinge.

At 1014, the visual indicia of 1013 depict another electronic device having another first device housing that is pivotable about another hinge relative to another second device housing with the another first device housing pivoted about the another hinge relative to the another second device housing partially between the axially displaced open position and the closed position. At 1015, the visual indicia of 1012 instruct how to transform the deformable device housing to match the deformed geometry.

At 1016, the one or more processors of 1015 remove the visual indicia when the deformable housing transitions to substantially match the deformed geometry while the content is being presented. At 1017, the content of 1012 comprises a screen shot captured by the originating electronic device while the originating electronic device was in a deformed geometric configuration.

At 1018, a method in an electronic device comprises receiving, by a user interface, user input requesting a presentation of content having written to its metadata at least one geometric configuration of an originating electronic device occurring when the content was created. At 1018, the method comprises presenting, by one or more processors on the user interface, the content within an electronic device depiction having the at least one geometric configuration until the electronic device transitions to the at least one geometric configuration.

At 1019, the at least one geometric configuration of 1018 comprises a deformed geometric configuration where a first device housing portion is skew relative to a second device housing portion. At 1020, the presentation of the content of 1019 on the user interface causes the content to appear on a display of the originating electronic device.

In the foregoing specification, specific embodiments of the present disclosure have been described. However, one of ordinary skill in the art appreciates that various modifications and changes can be made without departing from the scope of the present disclosure as set forth in the claims below. Thus, while preferred embodiments of the disclosure have been illustrated and described, it is clear that the disclosure is not so limited. Numerous modifications, changes, variations, substitutions, and equivalents will occur to those skilled in the art without departing from the spirit and scope of the present disclosure as defined by the following claims. For example

Accordingly, the specification and figures are to be regarded in an illustrative rather than a restrictive sense, and all such modifications are intended to be included within the scope of present disclosure. The benefits, advantages, solutions to problems, and any element(s) that may cause any benefit, advantage, or solution to occur or become more pronounced are not to be construed as a critical, required, or essential features or elements of any or all the claims.

What is claimed is:

1. A method in an electronic device, the method comprising presenting, by a user interface, content with visible indicia indicating an originating electronic device geometric configuration at which the content was created unless a geometric configuration of the electronic device substantially matches the originating electronic device geometric configuration.

2. The method of claim 1, wherein the originating electronic device geometric configuration is written to metadata of the content.

3. The method of claim 1, wherein the visible indicia depict an originating electronic device.

4. The method of claim 3, wherein the content is presented on a display of the originating electronic device.

5. The method of claim 4, wherein the visible indicia depict the originating electronic device in a partially deformed geometry defined by the originating electronic device geometric configuration.

6. The method of claim 5, wherein the visible indicia depict the originating electronic device having a first device housing that is pivotable about a hinge relative to a second device housing between an axially displaced open position and a closed position.

7. The method of claim 6, wherein the visible indicia further depict the originating electronic device with the first device housing pivoted relative about the hinge relative to the second device housing partially between the axially displaced open position and the closed position.

8. The method of claim 1, wherein the visible indicia comprise instructions for transitioning the electronic device to the originating electronic device geometric configuration.

9. The method of claim 1, further comprising:
monitoring, using one or more sensors, changes in the geometric configuration of the electronic device while the content is presented; and
removing, by the user interface, the visible indicia when the changes in the geometric configuration cause the geometric configuration to substantially match the originating electronic device geometric configuration.

10. The method of claim 1, wherein the originating electronic device geometric configuration comprises multiple geometric configurations that occurred in an originating electronic device while the content was created.

11. The method of claim 1, wherein the visible indicia indicating the originating electronic device geometric configuration at which the content was created is always presented with the content when a device housing of the electronic device is non-deformable.

12. An electronic device, comprising:
a deformable device housing supporting at least one display;
one or more sensors operable to detect a geometric configuration of the deformable device housing; and
one or more processors operable with the one or more sensors;
the one or more processors presenting content identifying a deformed geometry at which an originating electronic device was configured when creating the content with visual indicia identifying the deformed geometry unless the one or more sensors detect the deformable device housing substantially matching the deformed geometry.

13. The electronic device of claim 12, wherein:
the deformable device housing comprises a first device housing that is pivotable about a hinge relative a second device housing between an axially displaced open position and a closed position; and
the at least one display comprises a flexible display coupled to the first device housing and the second device housing and spanning the hinge.

14. The electronic device of claim 13, wherein the visual indicia depict another electronic device having another first device housing that is pivotable about another hinge relative to another second device housing with the another first device housing pivoted about the another hinge relative to the another second device housing partially between the axially displaced open position and the closed position.

15. The electronic device of claim 12, wherein the visual indicia instruct how to transform the deformable device housing to match the deformed geometry.

16. The electronic device of claim 15, the one or more processors removing the visual indicia when the deformable housing transitions to substantially match the deformed geometry while the content is being presented.

17. The electronic device of claim 12, wherein the content comprises a screen shot captured by the originating electronic device while the originating electronic device was in a deformed geometric configuration.

18. A method in an electronic device, the method comprising:
receiving, by a user interface, user input requesting a presentation of content having written to its metadata at least one geometric configuration of an originating electronic device occurring when the content was created; and
presenting, by one or more processors on the user interface, the content within an electronic device depiction having the at least one geometric configuration until the electronic device transitions to the at least one geometric configuration.

19. The method of claim 18, the at least one geometric configuration comprising a deformed geometric configuration where a first device housing portion is skew relative to a second device housing portion.

20. The method of claim 19, wherein the presentation of the content on the user interface causes the content to appear on a display of the originating electronic device.
